(19) United States
(12) Patent Application Publication
(10) Pub. No.: US 2012/0202182 A1
(43) Pub. Date: Aug. 9, 2012

(54) HYDROGEN ATOM MODEL AS EDUCATIONAL TOOL

(76) Inventor: Haruo Matsushima, Yamatokooriyama-shi (JP)

(21) Appl. No.: 13/302,281

(22) Filed: Nov. 22, 2011

(30) Foreign Application Priority Data
Feb. 7, 2011 (JP) 2011-039007

(51) Int. Cl. G09B 23/26

(52) U.S. Cl. 434/280

(57) ABSTRACT

A hydrogen atom model is a three-dimensional model or planar drawing which expresses an electric field in a form of electric lines of force and a magnetic field in a form of magnetic lines of force. The electric field is obtained by a gradient vector operation applied to an electric potential and a sign inversion to the result of the vector operation. The electric potential is a wave function of any one of orbitals of a hydrogen atom. The magnetic field is obtained by a rotational vector operation applied to a vector potential. The vector potential is the wave function regarded as a vector potential having a component only in a θ-direction of polar coordinates (r, θ, φ).

### REFERENCE TO RELATED APPLICATION

This application is based on Japanese patent application serial No. 2011-039007, filed with Japan Patent Office on Feb. 7, 2011. The content of the application is hereby incorporated by reference. The content of U.S. patent application Ser. No. 12/508,060 filed by the same applicant and published on Feb. 4, 2010 with publication No. US-2010-0028840-A1 is also hereby incorporated by reference.

### BACKGROUND OF THE INVENTION

1. Field of the Invention

The present invention relates to a hydrogen atom model as an educational tool useful for education of sciences.

2. Description of Related Art

It can be said that mathematical analyses are dominant in quantum mechanics, and therefore, educational tools that enable educands to have a concrete image for quantum mechanical systems are hardly found. Patent document 1 listed below, which the present applicant has filed, is one of scarce examples that have addressed an internal structure of a quantum system. FIG. 6 is a copy of FIG. 3 in patent document 1, and shows electric force lines of is orbital in a hydrogen atom.

The diagram, however, raises a question how distribution of an electric field asymmetric in terms of a z-axis is derived from a simple and spherically-symmetric wave function. Moreover, the basis and physical explanation on a presumption that a wave function can be treated as a vector potential are not persuasive. In addition, a there-stated opinion contradictory to special relativity theory is not acceptable.

However, an opinion that has pointed out inconsistency concerning probability interpretation of a wave function is acceptable. Not only Einstein who left well-known words “He does not throw dice” but also Shrodinger who was the father of quantum mechanics and reportedly regarded a wave function as something like a density of electric charge would no doubt agree with this opinion if they were still alive. An opinion stated in the present application is an extension of the same. Summary of the relevant part of patent document 1 will be presented here for reference. The summary can be stated as: “An existence probability(=r²Ψ₂ₛΨ₂ₛ*) is zero at r=2a₀, where Ψ₂ₛ is a wave function of a 2s orbital and a₀ is Bohr radius. Since a condition that r is constant in a spherical polar coordinate defines a spherical surface, the zero probability at the spherical surface (r=2a₀) shows that there is no intercommunication of an electron between the inside and outside of the surface.” This idea leads to a conclusion that hydrogen atoms having a 2s orbital are divided into two types, i.e., one where an electron revolves only inside the sphere of radius 2a₀, and the other where an electron revolves only outside the same.

Prior art documents referred to in the present application will be listed up here for convenience.

Patent document 1: US-2010-0028840-A1 (application Ser. No. 12/508,060);

Non-patent document 1: Shigenobu Sunagawa “Theoretical Electromagnetics” Kinokuniya Shoten (Japan);

Non-patent document 2: Noboru Sasao “Introduction to Electromagnetics” Iwanami Shoten (Japan); and

Non-patent document 3: Stephen Hawking “Albert Einstein” Penguin Books.

### BRIEF SUMMARY OF THE INVENTION

It is therefore an object of the present invention to solve the above-mentioned conventional problem, and to provide distribution of electric and magnetic fields in a hydrogen atom by reconsidering what a wave function of a hydrogen atom which is the origin of quantum mechanics is all about, to thereby enable an educand to have a concrete image or easily perform physical consideration concerning quantum mechanics which forms a basic of the sciences, and as a result, have an interest in the whole sciences.

One aspect of the present invention is directed to a hydrogen atom model. The hydrogen atom model according to the aspect of the present invention is a three-dimensional model or planar drawing which expresses an electric field. The electric field is expressed in a form of electric lines of force, for example. The electric field is obtained by a gradient vector operation applied to an electric potential and a sign inversion to the result of the vector operation. The electric potential is a wave function of any one of orbitals of a hydrogen atom.

Thus, the hydrogen atom model according to one aspect of the present invention, as an educational tool, visualizes the figure of an atom constituting material, is useful for a phenomenon analysis, and also allows an educand to have an interest in learning sciences.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view showing electric lines of force of a 2pz orbital of a hydrogen atom on a vertical cross-sectional plane defined by any constant azimuthal angle φ according to a first embodiment of the present invention;

FIG. 2 is a cross-sectional view showing electric lines of force of a 2px orbital of a hydrogen atom on a vertical cross-sectional plane defined by azimuthal angles φ of 0 and 180 degrees according to the first embodiment of the present invention;

FIG. 3 is a perspective view showing a three-dimensional model expressing electric and magnetic fields in a 2s orbital of a hydrogen atom according to a second embodiment of the present invention;

FIG. 4 is a perspective view showing a three-dimensional distribution of electric and magnetic fields in a 1s orbital of a hydrogen atom according to a third embodiment of the present invention;

FIG. 5 is a perspective view showing a three-dimensional distribution of electric and magnetic fields in a 2pz orbital of a hydrogen atom according to the third embodiment of the present invention;

FIG. 6 is a vertical cross-sectional view showing electric lines of force of a is orbital of a hydrogen atom according to conventional art;

FIG. 7 is a planar cross-sectional view showing magnetic lines of force of a 2px orbital of a hydrogen atom on a cross-sectional plane defined by polar angle θ of 90 degrees according to conventional art; and

FIGS. 8A to 8C are planar cross-sectional views showing standing wave orbitals of an electron revolving around a nucleus (FIGS. 8A and 8C) and showing a wave packet (FIG. 8B) of an electron according to conventional art.

### DESCRIPTION OF THE PREFERRED EMBODIMENTS

Hereinafter, preferred embodiments of the present invention will be described with reference to the accompanying drawings. Wave functions of a hydrogen atom having the first to fourth lowest energies are shown below in ascending order of energy, where a₀ is Bohr radius. Only the four wave functions are shown because those four functions well represent the feature of the vector operation, and in addition, orbitals having higher energies are more complicated and cannot easily represent the feature. Vectors will hereinafter be expressed by large and italic characters.

1s orbital(1/π)^{1/2} (1 /a₀)^{3/2} exp(−r/a₀) (1)

2s orbital(1/32π)^{1/2}(1/a₀)^{3/2}(2−r/a₀)exp(−r/2a₀) (2)

2pz orbital(1/32π)^{1/2}(1/a₀)_{5/2}r exp(−r/2a₀)cos θ (3)

2px orbital(1/32π)^{1/2}(1/a₀)_{5/2}r exp(−r/2a₀)sin θ cos φ (4)

An electric field 1 is obtained by a gradient vector operation (expressed by “grad” or a well known inverted triangular symbol) applied to any of these wave functions and a sign inversion to the result of the vector operation. The first embodiment illustrates drawings of electric lines of force of 2pz and 2px orbitals on vertical cross-sectional planes. These drawings well represent the feature of the operation. It is desirable for an atom model to express magnetic field 2 as well as electric field 1. The same operation as that shown in patent document 1 is adopted for magnetic field 2, as shown later. The second embodiment illustrates an atom model that has a sphere having a certain radius r. Part of the sphere has been cut off by planar surfaces defined by a certain polar angle θ or azimuthal angle φ. Line segments proportional in length to exact values obtained from one of the above-listed formulae are expressed on the surfaces of the crippled sphere. The atom model thus expresses the strength of electric and magnetic fields at any part of the orbital in three dimensions. A perspective drawing that shows electric lines of force 1 and magnetic lines of force 2 at once allows an educand to easily see the relation between the electric and magnetic fields for a simple system, such as is orbital. The third embodiment illustrates such a drawing. These embodiments will hereinafter be described referring to examples.

### FIRST EXAMPLE

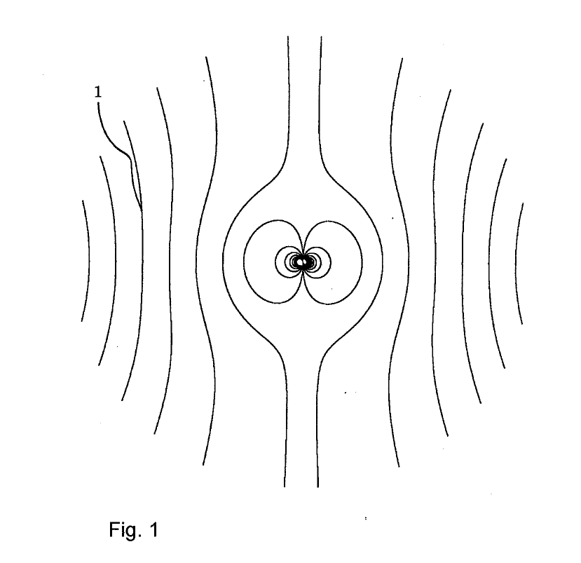

FIG. 1 illustrates a hydrogen atom model (drawing) as an educational tool according to the first embodiment of the present invention. The atom model shows electric lines of force of a 2pz orbital of a hydrogen atom on a vertical cross-sectional plane. Following formula (5) is obtained by applying a gradient vector operation to a wave function for the 2pz orbital shown in formula (3) and further applying a sign inversion to the result of the vector operation. Vectors iᵣ and i_{θ} are unit vectors in directions of r and θ, respectively.

E=(1/32π)^{1/2}(1/a₀)^{5/2} exp(−r/2a₀)·{iᵣ(r/2a₀−1)cos θ+i₀ sin θ} (5)

Electric lines of force 1 can be drawn by use of this formula through a process including steps of (S1) selecting any point on an rθ-plane as a starting point; (S2) substituting a set of coordinates (r, θ) of the selected starting point into formula (5) to obtain a vector E; (S3) calculating the second point distant from the first one by a small distance in a direction of the obtained electric field E; (S4) connecting the second point with the first point by a segment; (S5) substituting a set of coordinates of the second point into the formula (5) to obtain a vector E; (S6) calculating the third point distant from the second one by a small distance in a direction of the electric field E obtained at step (S5); (S7) connecting the third point with the second point by a segment; (S8) repeating steps (S5) through (S7) many times to draw a curve; (S9) selecting any other point on the rθ-plane than already selected starting point or points as another starting point; (S10) repeating steps of (S2) through (S8) to draw another curve; and (S11) repeating steps of (S9) and (S10) many times to obtain a group of curves, to complete electric lines of force 1. A drawing that shows electric lines of force 1 is obtained through the above-shown process. FIG. 1 illustrates electric lines of force 1 in a range that r is not larger than 6a₀. Since formula (5) does not include a coordinate φ, FIG. 1 provides electric lines of force 1 on any plane defined by a constant φ.

Two heart-like patterns of which the larger one holds the other smaller one therein in a breech position will appear if electric lines of force 1 are drawn in a precise manner based on formula (5). The wave function itself is, however, point-symmetric, and has a point-symmetric distribution even based on conventional interpretation of existence probability. For this reason, the process of obtaining a wave function from Shrodinger equation should be reviewed. As a result of the review, it has been found that a function cos° can be any of positive and negative values since the process includes a variable conversion of cos θ=w. Based on this result, point-symmetric electric lines of force 1 has been shown in FIG. 1.

### SECOND EXAMPLE

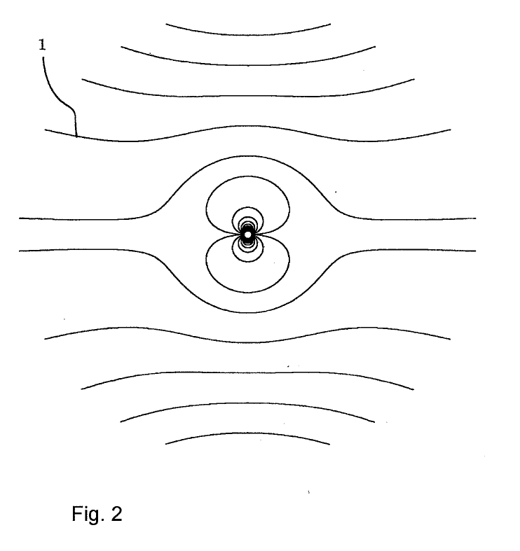

FIG. 2 illustrates a hydrogen atom model (drawing) as an educational tool according to the first embodiment of the present invention. The atom model expresses electric lines of force of a 2px orbital of a hydrogen atom on a vertical cross-sectional plane. Following formula (6) is obtained by applying a gradient vector operation to a wave function for the 2px orbital shown in formula (4) and further applying a sign inversion to the result of the vector operation. A vector i_{φ} is a unit vector in a φ direction.

E=(1/32π)^{1/2}(1/a₀)^{5/2} exp(−r/2a₀)·{iᵣ(r/2a₀−1)sin θ cos φ−i_{θ}cos θ cos φ+i_{φ} sin φ} (6)

Electric lines of force 1 on an rθ-plane defined by φ=0 and φ=180 degrees illustrated in FIG. 2 can be drawn through a process similar to that shown in Example 1 by use of formula (6) instead of formula (5) with φ=0 substituted therein.

### THIRD EXAMPLE

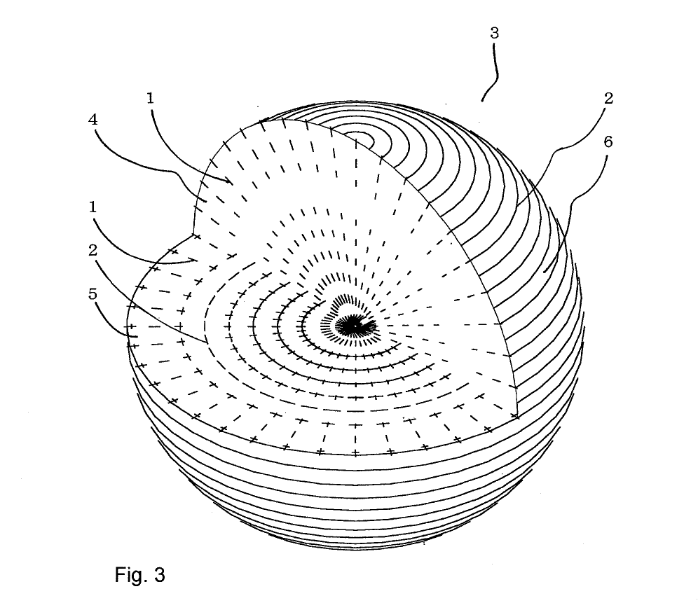

FIG. 3 illustrates a hydrogen atom model as an educational tool according to the second embodiment of the present invention. The atom model expresses distribution of electric and magnetic fields in a 2s orbital of a hydrogen atom. The atom model has a white-colored plastic sphere 3 having a radius of r=6 cm as an example. A quarter of the sphere 3 has been cut off with a vertical plane 4 defined by φ=0 and φ=180 degrees and a horizontal plane 5 defined by θ=90 degrees. Both components of electric field 1 and magnetic field 2 parallel to the surfaces of sphere 3, which include spherical surface 6, vertical plane 4 and horizontal plane 5, are drawn on the surfaces. The radius of the spherical surface 6 is regarded as r=6a₀.

Magnetic field 2 is obtained by the process shown in patent document 1. More specifically, magnetic field 2 is obtained as by a rotational vector operation applied to a vector potential. The vector potential is a wave function of the 2s orbital regarded as a vector potential having a component only in a θ-direction of polar coordinates (r, θ, φ).

The electric field E is obtained by applying a gradient vector operation to the wave function for the 2s orbital shown in formula (2) and further applying a sign inversion to the result of the vector operation. The obtained electric field E is shown by following formula (7).

E=(1/32π)^{1/2}(1/a₀)^{5/2}(2−r/2a₀)·exp(−r/2a₀)iᵣ (7)

We can see that the electric field E is zero at r=4a₀. The magnetic field His given by following formula (8).

H=(1/32π)^{1/2}(1/a₀)^{3/2}(2/r−3/a₀+r/a₀²)·exp(−r/2a₀)i_{φ} (8)

This formula (8) shows that magnetic field 2 is zero at r=(3−5^{1/2})a₀ and r=(3+5^{1/2})a₀. On horizontal plane 5, the electric and magnetic fields are drawn at each coordinate (r, φ), where the radius r increases from r=0.145a₀ with an interval of 0.618a₀ to include three points of r=(3−5^{1/2})a₀, r=4a₀, and r=(3+5^{1/2})a₀, and the azimuthal angle φ changes with an interval of 9 degrees. The electric field 1 and magnetic field 2 at each point are in general expressed by segments proportional in length to the strength thereof, although proportional to the logarithm thereof in an area where r is small because of too large values of those fields in the area. We can see that there are no segments of circumferential directions at the second largest radius r=(3+5^{1/2})a₀ and at the ninth largest radius r=(3−5^{1/2})a₀, and no segments of radial directions at the fourth largest radius r=4a₀.

### FOURTH EXAMPLE

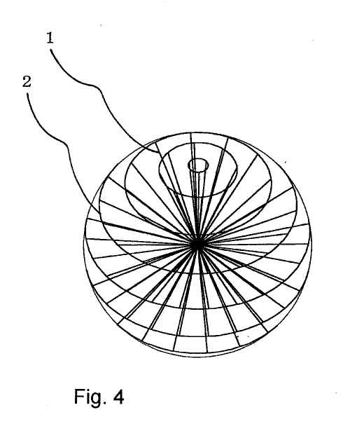

FIG. 4 illustrates a hydrogen atom model (drawing) as an educational tool according to the third embodiment of the present invention. The atom model expresses electric and magnetic lines of force of a 1s orbital of a hydrogen atom in a perspective view. The electric field E is obtained by applying a gradient vector operation to a wave function for the is orbital shown in formula (1) and further applying a sign inversion to the result of the vector operation. The obtained electric field E is shown by following formula (9).

E=(1/π)^{1/2}(1/a₀)^{5/2} exp(−r/a₀)iᵣ ) (9)

Electric lines of force 1, which are obtained by continuously connecting segments of the electric field E along the direction thereof, extend isotropically in radial directions. The magnetic field H is given by following formula (10).

H=(1/π)^{1/2}(1/a₀)^{5/2} exp(−r/a₀)i_{φ} (10)

Magnetic lines of force 2 show a pattern similar to the latitude lines of the earth. Both the electric and magnetic lines of force are shown together on the same drawing to show the relationship between the two.

### FIFTH EXAMPLE

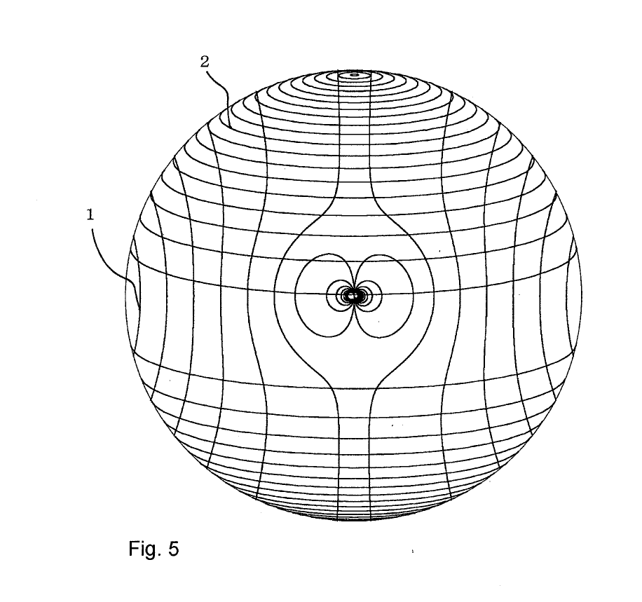

FIG. 5 illustrates a hydrogen atom model (drawing) as an educational tool according to the third embodiment of the present invention. The atom model expresses electric and magnetic lines of force of a 2pz orbital of a hydrogen atom. The magnetic field H is given by following formula (11).

H=(1/32π)^{1/2}(1/a₀)^{5/2}(2−r/2a₀)·exp(−r/2a₀)cos θi_{φ} (11)

Magnetic lines of force 2 are expressed by circles in a perspective view. Intervals between the circles are set proportional to 1/cos θ to illustrate that the circles are dense at the top and bottom and thin at the middle. Electric lines of force 1 shown in FIG. 1 are combined with the circles.

Hereinafter, the operation and function of the educational tools configured as stated above will be described. First, the wave function is interpreted as density distribution of electric charge, which Shrodinger may have recommended. Since Shrodinger equation treats work or energy related to momentum and potential, the wave function, which is a solution of the equation, can quite reasonably be seen to have the same unit. An electric potential (electrostatic potential) is found as a work related to an electric charge distribution. Page 90 of non-patent document 1 shows a function containing a Legendre polynomial for an electrostatic potential (electric potential) formed by distribution of point electric charges. Once the wave function of a hydrogen atom is assumed to be an electric potential, the electric field in a hydrogen atom can be obtained by applying a gradient vector operation to the wave function and further applying a sign inversion to the result of the vector operation. As described later, the result of the calculation is very simple and applicable also to s orbitals. There still remains some concern about how to treat an electric field formed by a positive charge of a proton. The same page of non-patent document 1 describes that a term of Legendre polynomial having l=0 represents an electric potential for all the distributed electric charges regarded as being condensed at the origin. We can, therefore, see that the electric field formed by a proton has already been included, cancelled, deducted or added in the electric field calculated by the above-mentioned procedure.

The magnetic field should more carefully be examined. The magnetic field obtained by applying the rotational vector operation to the electric field is complicated and can hardly be adopted. Therefore, apart from an advanced (?) theory, basic knowledge on static electromagnetic fields will be reviewed.

Page 111 of non-patent document 2 states that an electric potential φ(r) formed by an electric charge density ρₑ(r′) is expressed by following formula (12).

φ(r)=(1/4πε₀)∫ρₑ(r′)/|r−r′|dv′ (12)

If a wave function is an electric potential, a relation between the wave function and an equivalent distributed charge density formed by an electron can be expressed by formula (12). The same page of the document also expresses a vector potential A(r) by following formula (13) similar to formula (12). Here, jₑ(r′) is an electric current density.

A(r)=(μₒ/4π)∫jₑ(r′)/|r−r′|dv′ (13)

The electric charge density ρₑ(r′) in formula (12) can be regarded as representing an electric charge distribution similar to that of a standing wave formed by an electron revolving around the origin. In addition, the electric charge density ρe(r′) can also be regarded as an expression of a state of a revolving electric charge at a certain moment, considering a fact that an electron revolves. If this view is true, the electric charge density ρₑ(r′) will also be an electric current density. Thus, a wave function, which can be regarded as a function of an equivalent distributed charge density around the origin, can be regarded as forming a vector potential as an electric current density to express a revolving state of an electron, and also forming an electric potential to express a momentary state of an electron.

The direction of the revolution will be a combined direction of r and θ-components if the orbital of a revolving electron is oval. However, the direction of the revolution in an s orbital which defines a spherically symmetric wave function can be concluded being a θ-direction with raising no problem. This means that the wave function is regarded as a θ-directional vector potential. As a result, the wave function is the same as the magnetic field given in patent document 1. Wave functions are regarded as θ-directional for all orbitals not because of inspiration from patent document 1 which regards the magnetic field as θ-directional for p, d and other orbitals as well as for an s orbital but because of no reason for discriminating p, d and other orbitals from an s orbital. It is, as a matter of course, a premise of the hypothesis that the results of the hypothesis do not conflict with any physical law and do not have an inconsistency therein.

The limitation to the θ-directional motion means a restrictive interpretation that an electron revolves on a plane parallel to a z-axis. An electron that revolves crossing the z-axis at a certain moment can be supposed to gradually incline a rotational plane thereof and be away from the axis with time. The limitation to the θ-directional motion can be said to exclude the supposition. The rotation crossing the z-axis shown as only one example corresponds to one of subsets. Another subset which defines a revolution crossing an axis inclined by an angle θ₁ from the z-axis can be obtained by inclining the subset that defines a revolution crossing the z-axis by the angle θ₁. Therefore, a subset, as long as providing a meaningful result, is useful rather than a complicated universal set which provides no meaningful result.

As we can see in the electric and magnetic fields in a 2pz orbital shown in FIG. 5, magnetic field 2 derived under the above-mentioned limitation and the electric field 1 derived without the limitation are both strong in the same region. Therefore, the limitation of the revolving direction of an electron to a θ-direction may be supposed to result in a drawing that expresses the universal set, although this supposition has not yet been verified. Either way, one aspect of the present invention is directed to magnetic field 2 derived from the above-mentioned θ-directional limitation.

In summary, one aspect of the present invention is directed to a hydrogen atom model. The model is a drawing, such as a planer drawing, or three-dimensional model which expresses electric field 1 with lines or segments representing the direction and strength of the electric field 1. The electric field 1 is obtained by a gradient vector operation applied to an electric potential (electrostatic potential) and a sign inversion to the result of the vector operation. The electric potential is a wave function of any one of orbitals of a hydrogen atom.

Another aspect of the present invention is also directed to a hydrogen atom model. The model is a planar drawing, such as a perspective view, or three-dimensional model which expresses an electric field in the same manner as the one aspect of the present invention does, and in addition, expresses a magnetic field 2 in the same manner as patent document 1 discloses. In more detail, the magnetic field 2 is obtained by a rotational vector operation applied to a vector potential, the vector potential being a wave function regarded as a vector potential having a component only in a θ-direction of polar coordinates (r, θ, φ).

Results of the aspects of the present invention will hereinafter be described. The aspects of the present invention, in a manner, visualize the inside of a hydrogen atom, and thereby, allow educands to understand how a difference in a wave function causes a difference in the internal structure. For example, electric lines of force 1 are independent of an angle and extend radially and outwardly in s orbitals, whereas are, having θ-components, curved in p orbitals. Electric fields 1 in 2pz and 2px orbitals both belonging to p orbitals are only different in an orientation by 90 degrees from each other as shown in FIGS. 1 and 2. On the other hand, magnetic fields 2 are noticeably different from each other as shown in FIG. 5 which is a perspective view of both of the electric and magnetic fields and FIG. 7 which is a horizontal cross-sectional view of magnetic field 2 in a 2px orbital and is FIG. 6 of patent document 1.

In the three-dimensional model shown in FIG. 3, components of electric and magnetic fields at each point on each surface parallel to the surface are expressed with segments each having a length corresponding to strength of the electric or magnetic field. Positions where the electric or magnetic field is zero can easily be found in FIG. 3. As regards FIG. 4, we can easily see that a 1s orbital is almost spherically symmetric and has a simple structure from radial electric lines of force 1 and magnetic lines of force 2 similar in shape to the latitude lines of the earth.

Energy shown in patent document 1 can be calculated from an electric field obtained through the procedure provided by the present invention. The energy of 1/(a₀²n²) is obtained by a volume integration of square of an electric field in an ns orbital over the whole space. This energy is proportional to Bohr energy level, and also identical with energy of the magnetic field calculated based on the procedure disclosed in patent document 1. This result backs up the lossless resonator theory proposed in patent document 1 and will be a collateral evidence for the theory that a wave function is an electric potential.

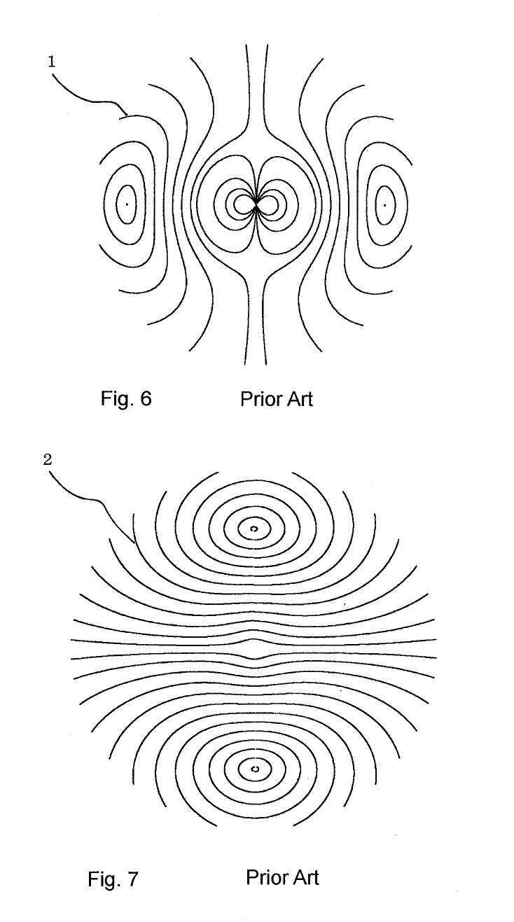

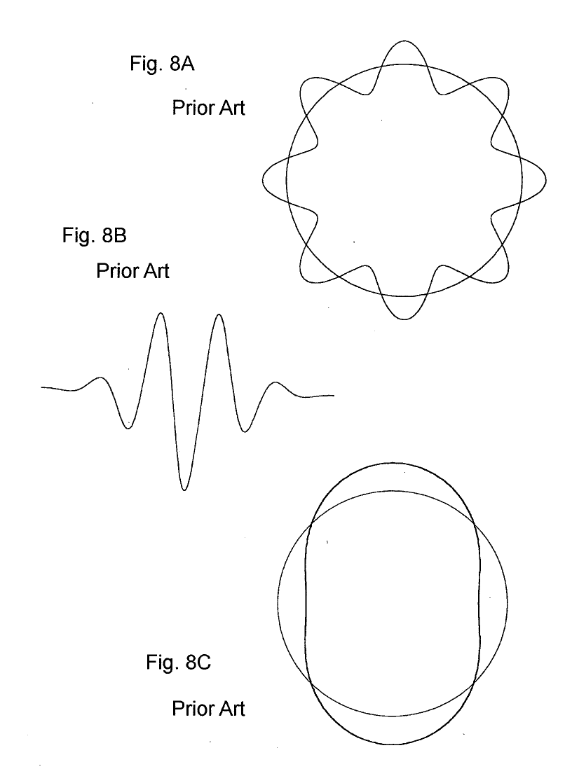

At the end of description of the results, it should be emphasized that the theory “a wave function does not represent a probability amplitude but an electric potential” on which the present invention is based is applicable only to inside of an atom where standing wave is formed, and not applicable to an electron freely traveling the space, such as an electron in the two-slit experiment. It should also be noted that the theory does not deny the uncertainty principle. FIG. 8B illustrates a wave packet which is frequently found in textbooks and is said to represent both of particle and wave natures. The wave packet, as an example, has four peaks which include two higher and two lower peaks. FIG. 8A illustrates a standing wave of an electron revolving around a nucleus, which is also found in many textbooks. The standing wave, as an example, has eight positive and eight negative peaks. FIG. 8C illustrates a 2p orbital, which has been so rewritten as to have two positive and two negative peaks in one loop. Superposition of these two positive peaks in the loop and the four positive peaks in the wave packet illustrated in FIG. 8B will result in one wave packet standing in one loop with the front and back halves of the wave packet overlapped. In such a wave, it will be meaningless to make an inquiry where (the center of) the wave packet exists or where the position of an electron is. The present invention only clarifies this point.

Next, there will be provided an explanation that a light velocity electron proposed in patent document 1 is not denied nor modified. Once we carefully read a paper written by Einstein, we can find a fact that the theory is only applicable to a velocity lower than the light velocity and not applicable to the light velocity. English version of non-patent document 3 (of which Japanese version is published in “Iwanami Paperback Edition”) can be summarized that the theory is constructed by defining an equal time between static and inertial systems by “a relationship between a time when light is emitted from the static system, a time when the light is reflected by the inertial system, and a time when the reflected light returns to the static system.” If a velocity of the inertial system moving away from the static system is supposed to be the light velocity, the light emitted from the static system cannot reach the inertial system moving away at the same velocity, and therefore, the equal time cannot be defined. The equal time can only be defined under a lower velocity than the light velocity, and the light velocity electron cannot be denied based on special relativity theory.

It should be noted that a three-dimensional model can easily formed by combining straight wires or the like radially extending from a central point and wire rings having plural different radii using an analogy from the perspective view of FIG. 4. Another three-dimensional model that has two transparent discs connected with each other at a right angle as shown in FIG. 9 of patent document 1 is also easily formed on the basis of FIGS. 2 and 7 of the present application. Although the word “model” in the title of the present invention may be associated with a three-dimensional structure from its ordinary meaning, the word means an educational tool that models or represents a hydrogen atom and includes drawings, such as cross-sectional views and perspective views as described above. Although applying a rotational vector operation to formula 13 will result in a magnetic flux B which is different from a magnetic field H by a coefficient of magnetic permeability μ₀, the magnetic lines of forces have no difference between the two, and therefore, the difference by the magnetic permeability μ₀ was not referred to.

As described above, the present invention advantageously raises educands' interest in sciences, and especially quantum mechanics, with the drawings or the three-dimensional models representing the internal structure of an atom and helps to prevent them from going away from sciences, and furthermore, prevent their misunderstanding that can be caused by inference only weighted in mathematics. In addition, the present invention enables calculation of energy levels of a hydrogen atom and is expected to contribute to education for quantum mechanics.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

As described above, a hydrogen atom model as an educational tool in accordance with the present invention visualizes the figure of a hydrogen atom, enables educands to have a close feeling toward hardly understood or approached quantum mechanics, prevents them from going away from sciences, and is therefore useful for education and research.

What is claimed is:

1. A hydrogen atom model as an educational tool, comprising one of a drawing and a three-dimensional model expressing an electric field obtained by a gradient vector operation applied to an electric potential and a sign inversion to a result of the vector operation, the electric potential being a wave function of any one of orbitals of a hydrogen atom.

2. The hydrogen atom model according to claim 1, wherein the any one of orbitals is any one of 1s, 2s, 2px, 2py and 2pz orbitals.

3. The hydrogen atom model according to claim 1, wherein the electric field is expressed in a form of electric lines of force.

4. The hydrogen atom model according to claim 1, wherein the one of a drawing and a three-dimensional model further expresses a magnetic field, the magnetic field being obtained by a rotational vector operation applied to a vector potential, the vector potential being the wave function regarded as a vector potential having a component only in a θ-direction of polar coordinates (r, θ, φ).

5. The hydrogen atom model according to claim 4, wherein the magnetic field is expressed in a form of magnetic lines of force.

6. The hydrogen atom model according to claim 4, wherein the hydrogen atom model comprises a three-dimensional model, the three-dimensional model includes a sphere of which part has been cut-off, and both components of the electric field and the magnetic field parallel to surfaces of the sphere are drawn on the surfaces.

7. The hydrogen atom model according to claim 6, wherein a quarter of the sphere has been cut off with a vertical plane defined by φ=0 and φ=180 degrees and a horizontal plane defined by θ=90 degrees.

8. The hydrogen atom model according to claim 4, wherein the hydrogen atom model comprises a drawing expressing the electric field and the magnetic field in a perspective view, the electric field is expressed in a form of electric lines of force, and the magnetic field is expressed in a form of magnetic lines of force.

9. The hydrogen atom model according to claim 4, wherein the hydrogen atom model comprises a drawing expressing the electric field in a cross-sectional view and the magnetic field in a perspective view, the electric field is expressed in a form of electric lines of force, and the magnetic field is expressed in a form of magnetic lines of force.

10. The hydrogen atom model according to claim 4, wherein the hydrogen atom model comprises a three-dimensional model, the electric field is expressed in a form of electric lines of force by use of wires, and the magnetic field is expressed in a form of magnetic lines of force by use of wires.
